(19) United States
(12) Patent Application Publication
(10) Pub. No.: US 2015/0159805 A1
(43) Pub. Date: Jun. 11, 2015

(54) MOUNTING UNIT OF DRIVING DEVICE FOR VEHICLE

(71) Applicant: Hyundai Motor Company, Seoul (KR)

(72) Inventors: Chang Ha Lee, Yongin (KR); Hyuck Roul Kwon, Yongin (KR)

(21) Appl. No.: 14/319,522

(22) Filed: Jun. 30, 2014

(30) Foreign Application Priority Data
Dec. 10, 2013 (KR) 10-2013-0153189

(51) Int. Cl. F16M 13/02; B60K 11/06; F16F 15/08; B60K 11/04

(52) U.S. Cl. CPC F16M 13/02; B60K 11/04; B60K 11/06; F16F 15/08

(57) ABSTRACT

A mounting unit of a driving device for a vehicle is provided that attaches a driving device having a rotary component to a vehicle body. The mounting unit includes a mounting bracket attached to the vehicle body and rubber bushes respectively disposed at both sides of the mounting bracket corresponding to a first side of the driving device and at a substantial center of the mounting bracket corresponding to a second side of the driving device, and the rubber bushes are configured to fix the mounting bracket to the driving device using a plurality of mounting bolts.

### CROSS-REFERENCE TO RELATED APPLICATION

This application claims priority to and the benefit of Korean Patent Application No. 10-2013-0153189 filed in the Korean Intellectual Property Office on Dec. 10, 2013, the entire contents of which are incorporated herein by reference.

### BACKGROUND

(a) Field of the Invention

The present invention relates to a fuel cell vehicle, and more particularly, to a mounting unit of a driving device for a vehicle for attaching driving devices such as an air compressor, an air blower, and a water pump provided within a fuel cell vehicle to a vehicle body.

(b) Description of the Related Art

In general, a fuel cell vehicle has a fuel cell system that operates as a power supply for driving a driving motor to generate electrical energy by an electrochemical reaction between hydrogen and air by a fuel cell. The fuel cell system includes a stack in which fuel cells are stacked, a hydrogen supply unit configured to supply hydrogen to the stack, an air supply unit configured to supply air to the stack, and a heat and water managing unit configured to discharge reaction heat of the stack to the exterior of the system and adjust an operation temperature of the stack.

In particular, the air supply unit includes an air compressor or an air blower driven by receiving a power, and is configured to compress air in the atmosphere to supply the compressed air to the stack. Further, the heat and water managing unit includes a water pump driven by receiving a power to cool heat generated in the stack using cooling water and is configured to pump the cooling water to the stack.

As described above, the driving devices such as the air compressor, the air blower and the water pump substantially high speed, and support the rotor through a high-speed precision bearing. Since vibration of a vehicle body generated when the vehicle accelerates or decelerates and a considerably substantial vibration or impact are transferred to typical vehicle components and the ground, measures for the vibrations and impact are required. Particularly, since the driving devices as main components of the fuel cell vehicle, such as the air compressor, the air blower and the water pump, include precision components that rotate at a substantial high speed, it may be necessary to provide means for suppressing such a vibration from being minimally transferred to the components.

Moreover, when the driving device is operated, since the vibration generated by the component that rotates at a substantial high speed is transferred to a driver or is transferred to the driver as noise, inconvenience to the driver may occur. Accordingly, to prevent the inconvenience, it may be necessary to minimize the vibration of the vehicle body from being transferred to the driving device and to minimize the vibration generated in the driving device from being transferred to the vehicle body. Accordingly, for example, the fuel cell vehicle may include a mounting structure that supports both left and right sides of a lower end of the driving device by a mounting bracket attached to the vehicle body using four or more rubber bushes.

Such a mounting structure may be simple to manufacture or design. However, when the rubber bushes are disposed at the lower end of the driving device, since the vibration of the vehicle body is transferred to the component, the rubber bushes may be damaged. Specifically, when the lower end of the driving device is attached to the mounting bracket through the rubber bushes and when the vehicle body moves or vibrates in a back and forth direction or left and right direction, rubber bushes having substantial low stiffness and damping may be deformed. In addition, the driving device attached to an upper end of the mounting bracket vibrates with substantial displacement in the back and forth direction and in the left and right direction. Accordingly, since considerably high stress is applied to the rubber bushes, the rubber bushes may be damaged.

To prevent the rubber bushes from being damaged, since it is necessary to secure durability of the rubber bush, the stiffness of the rubber bush may be increased by changing a rubber material of the rubber bush or reinforcing a shape thereof. However, when the rubber bush has excessively high stiffness, since the vibration generated in the diving device is transferred to the vehicle body, the driver may feel the noise or vibration, in other words, to reduce the vibration transferred to the driving device from the vehicle body, a strong rubber bush having more than appropriate stiffness may be required, and to insulate the vibration generated to the vehicle body from the driving device, a rubber bush having substantial low stiffness may be required.

The above information disclosed in this section is merely for enhancement of understanding of the background of the invention and therefore it may contain information that does not form the prior art that is already known in this country to a person of ordinary skill in the art.

### SUMMARY

The present invention provides a mounting unit of a driving device for a vehicle that may suppress vibration generated in a driving device from being transferred to a vehicle body while suppressing impact transferred to the driving device from the vehicle body. Further, the present invention provides a mounting unit of a driving device for a vehicle that may maintain durability of a rubber bush by positioning the rubber bush at a predetermined position and by improving a shape of a mounting bracket to reduce displacement of a driving device and of suppressing vibration from being transferred to a vehicle body by reducing stiffness of the rubber bush.

An exemplary embodiment of the present invention provides a mounting unit of a driving device for a vehicle for attaching a driving device having a rotary component to a vehicle body, the mounting unit may include: a mounting bracket attached to the vehicle body; and a plurality of rubber bushes respectively disposed at both sides of the mounting bracket corresponding to one side (e.g., a first side) of the driving device and at a substantial center of the mounting bracket corresponding to the other side (e.g., a second side) of the driving device, and fix the mounting bracket to the driving device using mounting bolts.

Further, in the mounting unit of a driving device for a vehicle according to the exemplary embodiment of the present invention, the rubber bushes may be respectively disposed at both left and right sides of any one of a front and a rear of the mounting bracket corresponding to the first side of the driving device and at a substantial center of the second side corresponding to the second side of the driving device using a back and forth direction, a left and right direction, and an up and down direction (e.g., vertical) of the mounting bracket as a reference.

Additionally, in the mounting unit of a driving device for a vehicle according to the exemplary embodiment of the present invention, the rubber bushes may be respectively disposed at both left and right sides of a rear of the mounting bracket corresponding to a rear of the driving device and at a substantial center of a front of the mounting bracket corresponding to a front of the driving device using a back and forth direction, a left and right direction, and a vertical direction of the mounting bracket as a reference. The rubber bushes may also be respectively disposed at both left and right sides of a rear of the mounting bracket corresponding to a rear of the driving device and at a substantial center of a front of the mounting bracket corresponding to a substantially central lower portion of a front of the driving device using a back and forth direction, a left and right direction, and a vertical direction of the mounting bracket as a reference.

The mounting bracket may support the driving device in a three-point supporting manner using the rubber bushes. The mounting bracket may also include first and second supporting points positioned at both sides to support the first side of the driving device using the rubber bushes, and a third supporting point positioned at the substantial center to support the second side of the driving device through the rubber bush,

Furthermore, in the mounting unit of a driving device for a vehicle according to the exemplary embodiment of the present invention, the mounting bracket include first and second supporting points positioned at both sides of the rear to respectively support the both sides of the rear of the driving device using the rubber bushes to be vertically symmetrical, and a third supporting point positioned at the substantial center of the front to support the substantially central lower portion of the front of the driving device through the rubber bush. The rubber bushes at the first and second supporting points may be disposed at the substantial center of mass of the driving device. In addition, the mounting bracket may include a first part that supports the second side of the driving device, and second parts that are integrally connected to both ends of the first part, and support the first side of the driving device.

In particular, the second parts may include connection ends connected to the both ends of the first part, and free ends that correspond to the connection ends. The first and second supporting points may be disposed at positions extending upwards from the free ends of the second parts, and the third supporting point may be disposed at a substantial center of the first part. Additionally, the rubber bush may include an outer pipe attached to each of the supporting points of the mounting bracket, an inner pipe disposed within the outer pipe, and an insulator positioned between the outer pipe and the inner pipe and bonded onto an inner surface of the outer pipe and an outer surface of the inner pipe.

According to an exemplary embodiment of the present invention, when the impact is transferred to the driving device from the vehicle body and the vibration generated in the driving device is transferred to the vehicle body, it may be possible to effectively attenuate the impact transferred to the driving device from the vehicle body and the vibration transferred to the vehicle body from the driving device while minimizing displacement in the back and forth direction and in the left and right direction of the driving device. Furthermore, it may be possible to reduce stress applied to the rubber bushes by minimizing the displacement in the back and forth direction and in the left and right direction of the driving device. The rubber bushes may be designed to allow the rubber bushes to have a shape and a material having substantial low stiffness, and it may be possible to improve performance of the vehicle by reducing the stiffness of the rubber bushes to suppress the vibration generated in the driving device from being transferred to the vehicle body. The manufacturing cost may also be reduced using three rubber bushes, unlike the related art in which four or more rubber bushes are used.

### BRIEF DESCRIPTION OF THE DRAWINGS

These drawings are presented to describe exemplary embodiments of the present invention, and, thus, the technical spirit of the present invention should not be interpreted as being limited to the accompanying drawings.

FIG. 1 is an exemplary view of a mounting unit of a driving device for a vehicle according to an exemplary embodiment of the present invention;

FIG. 2 is an exemplary front view of the mounting unit of a driving device for a vehicle according to the exemplary embodiment of the present invention;

FIG. 3 is an exemplary view of the mounting unit of a driving device for a vehicle according to the exemplary embodiment of the present invention;

FIG. 4 is an exemplary side view of the mounting unit of a driving device for a vehicle according to the exemplary embodiment of the present invention; and

FIG. 5 is an exemplary cross-sectional view a rubber bush applied to the mounting unit of a driving device for a vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are illustrated. As those skilled in the art would realize, the described embodiments may be modified in various different ways, all without departing from the spirit or scope of the present invention. Unrelated parts will be omitted to clearly describe the present invention, and throughout the specification, the same or similar constituent elements will be assigned the same reference numeral. In the drawings, sizes and thicknesses of components are arbitrarily illustrated for the convenience in description, and, thus, the present invention is not necessarily limited to the drawings. The thicknesses thereof are thickly illustrated to clarify various portions and regions.

Further, in the following detailed description, the terms ‘first,’ ‘second,’ etc. given to components having the same configuration are only used to distinguish one component from another, and the terms do not necessarily denote any order in the following detailed description. Throughout the specification, the terms “ . . . unit,” “ . . . means,” “ . . . part,” “member,” etc. described in the specification means a unit having a comprehensive configuration so as to perform at least one function or operation.

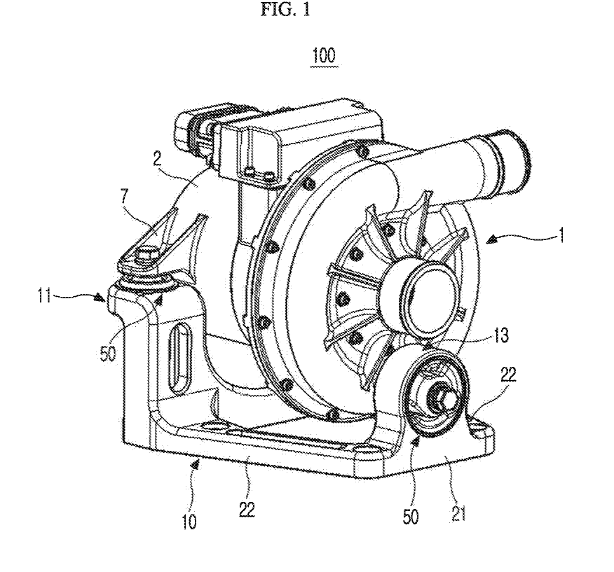

FIG. 1 is an exemplary view illustrating a mounting unit of a driving device for a vehicle according to an exemplary embodiment of the present invention. Referring to FIG. 1, a mounting unit 100 of a driving device for a vehicle according to an exemplary embodiment of the present invention may be applied to a vehicle provided with a driving device 1 driven by receiving a power. For example, the mounting unit 100 of a driving device for a vehicle according to the exemplary embodiment of the present invention may be applied to a fuel cell vehicle configured to generate electrical energy by an electrochemical reaction between hydrogen and oxygen by a fuel cell system and may be configured to operate a driving motor using the electrical energy.

The driving device 1 may be disposed at the fuel cell system, and may include an air compressor, an air blower, and a water pump including a rotary component such as a rotor that rotates at a substantial high speed. The air compressor and the air blower maybe configured to compress air in atmosphere to supply the compressed air to a fuel cell stack, and the water pump may be configured to pump cooling water stored in a reservoir to supply the cooling water to the fuel cell stack. The driving device 1 may be disposed within various vehicles types such as ordinary vehicles, hybrid vehicles and electric vehicles, and, for example, an air compressor in the driving device 1 disposed within the fuel cell system of the fuel cell vehicle will be described below. However, it should be understood that the scope of the present invention is not necessarily limited to the above-described example, and a variety of driving devices capable of being applied to various types of vehicles for various purposes can be applied to the technical spirit of the present invention.

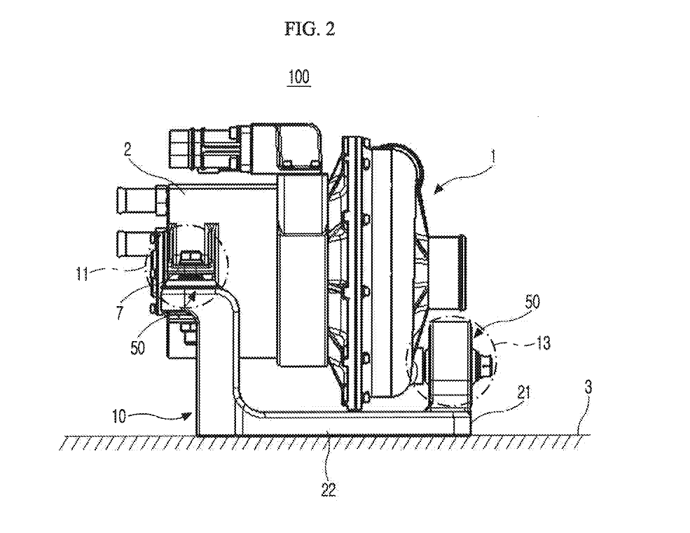

The driving device 1 may be attached to a vehicle body 3 (hereinafter, see FIG. 2) of the vehicle to be fixed thereto, and a housing 2 may be fixed to the vehicle body 3. The mounting unit 100 of a driving device for a vehicle according to the exemplary embodiment of the present invention may be configured to attach the driving device 1 to the vehicle body 3, and to attenuate a vibration generated in the vehicle body 3 to protect the driving device 1 and to prevent a vibration caused by the driving of the driving device 1 from being transferred to the vehicle body 3. In other words, d the mounting unit 100 of a driving device for a vehicle may be configured to suppress the vibration generated in the driving device 1 from being transferred to the vehicle body 3 while suppressing impact from being transferred to the driving device 1 from the vehicle body 3.

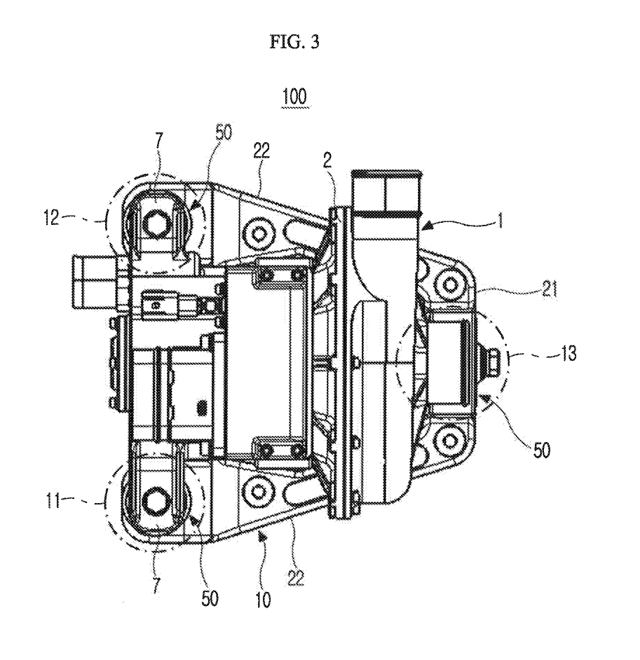

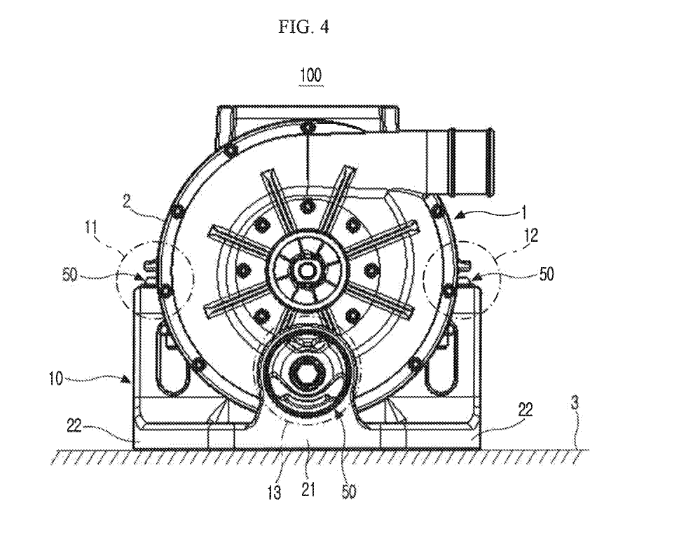

FIG. 2 is an exemplary front view of the mounting unit of a driving device for a vehicle according to the exemplary embodiment of the present invention, FIG. 3 is another exemplary view of the mounting unit of a driving device for a vehicle according to the exemplary embodiment of the present invention, and FIG. 4 is an exemplary side view of the mounting unit of a driving device for a vehicle according to the exemplary embodiment of the present invention. Referring to FIGS. 1 to 4, the mounting unit 100 of a driving device for a vehicle according to the exemplary embodiment of the present invention basically may include a mounting bracket 10 and a plurality of rubber bushes 50.

Hereinafter, a direction of each constitutive element is defined as a back and forth direction, a left and right direction, or an up and down direction on the drawings (e.g., x-axis, y-axis, and z-axis directions), However, since the definition of the direction as described above is merely used as a relative term and the direction thereof may change based on an attachment position of the mounting unit 100 and a direction of the vehicle body 3, the reference direction is not necessarily limited to the reference direction of the present exemplary embodiment.

The mounting bracket 10 may be used to attach the driving device 1 to the vehicle body 3, and may be attached to the vehicle body 3 to be fixed thereto. For example, the mounting bracket 10 may be attached to the vehicle body 3 via welding or bolting. In the exemplary embodiment of the present invention, the mounting bracket 10 may be configured to support the driving device 1 in a three-point supporting manner, as illustrated in FIGS. 3 and 4.

The mounting bracket 10 may include first and second supporting points 11 and 12 positioned at both sides of the mounting bracket 10 to support one side (e.g., a first side) of the driving device 1, and a third supporting point 13 positioned at a substantial center to support the other side (e.g., a second side) of the driving device 1. In addition, the mounting bracket 10 may be respectively provided with the first and second supporting points 11 and 12 positioned at both sides of the rear of the mounting bracket 10 to respectively support the both sides of the rear of the driving device 1 to be vertically symmetrical. Further, the mounting bracket 10 may be provided with the third supporting point 13 positioned at a substantial center of the front of the mounting bracket 10 to support a substantially central lower portion of the front of the driving device 1.

In particular, when the first, second and third supporting points 11, 12 and 13 of the mounting bracket 10 are connected by an imaginary line (e.g., when they are visually connected and not physically connected), the imaginary line may have a triangular shape, and the supporting points may support both sides of the rear and the substantially central lower portion of the front of the driving device 1. Moreover, the first, second and third supporting points 11, 12 and 13 may be positioned to be distant from each other (e.g., at a predetermined spacing from each other). In addition, the first and second supporting points 11 and 12 of the mounting bracket 10 may support left and right sides with respect to the rear center corresponding to the substantial center of mass of the driving device 1, and the third supporting point 13 may support a substantially central lower portion (e.g., a lower end) of the front of the driving device 1 under the first and second supporting points 11 and 12. In other words, there may be a height difference between the third supporting point 13 and the first and second supporting points 11 and 12 in the vertical direction,

The mounting bracket 10 may include a first part 21 configured to support the other side (e.g., the second side or the front) of the driving device 1 and second parts 22 integrally connected to both ends of the first part 21 and support one side (e.g., a first side or the rear) of the driving device 1. The second parts 22 may include connection ends connected to both ends of the first part 21 and free ends that correspond to the connection ends. In particular, the first and second supporting points 11 and 12 may be disposed at positions that extend upwards from the free ends of the second parts 22, and the third supporting point 13 may be disposed at a substantial center of the first part 21.

Alternatively, although it has been described in the exemplary embodiment of the present invention that the third supporting point 13 may be configured to support the substantially central lower portion (e.g., the lower end) of the front of the driving device 1 under the first and second supporting points 11 and 12, the present invention is not necessarily limited thereto. The third supporting point 13 may be configured to support the substantially central upper portion (e.g., an upper end) of the front of the driving device 1 at an upper side of the first and second supporting points 11 and 12.

Furthermore, although it has been described in the exemplary embodiment of the present invention that the first and second supporting points 11 and 12 may be configured to support the both sides of the rear of the driving device 1 to be vertically symmetrical, and the third supporting point 13 may be configured to support the substantially central lower portion of the front of the driving device 1, the present invention is not necessarily limited thereto. The first and second supporting points 11 and 12 may be configured to respectively support both sides of the front of the driving device 1 to be vertically symmetrical, and the third supporting point 13 may be configured to support the substantially central lower portion of the rear of the driving device 1,

In the exemplary embodiment of the present invention, the rubber bushes 50 may be configured to connect the mounting bracket 10 and the driving device 1, and may be configured to fix the mounting bracket 10 to the driving device 1 via mounting bolts 60 and to attenuate the vibration transferred to the driving device 1 from the vehicle body 3 and the vibration transferred to the vehicle body 3 from the driving device 1. The rubber bushes 50 may be respectively disposed at the first, second and third supporting points 11, 12 and 13 of the mounting bracket 10 described above.

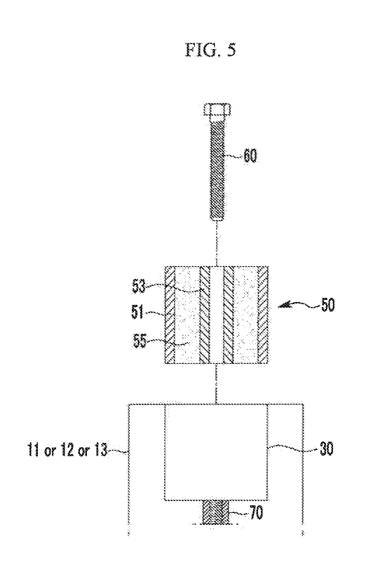

FIG. 5 is an exemplary cross-sectional view of the rubber bush applied to the mounting unit of a driving device for a vehicle according to the exemplary embodiment of the present invention. Referring to FIGS. 1 and 5, the rubber bushes 50 according to the exemplary embodiment of the present invention may include an outer pipe 51 attached to each of the supporting points 11, 12 and 13 of the mounting bracket 10, an inner pipe 53 disposed within the outer pipe 51, and an insulator 55 formed between the outer pipe 51 and the inner pipe 53.

The inner pipe 53 is a part to which the above-mentioned mounting bolt 60 may be connected, and the insulator 55 may be made of a rubber material that insulates the vibration. Accordingly, the insulator 55 may be vulcanized-bonded onto an inner surface of the outer pipe 51 and an outer surface of the inner pipe 53. In particular, an attachment part 30 into which the outer pipe 51 of the rubber bush 50 is inserted may be formed at each of the supporting points 11, 12 and 13 of the mounting bracket 10, and a weld nut 70 with which the mounting bolt 60 is screwed may be disposed at each of the first and second supporting points 11 and 12.

Moreover, mount ribs 7 configured to support the mounting bolts 60 may be formed at both left and right sides of the rear of the driving device 1 corresponding to the first and second supporting points 11 and 12 of the mounting bracket 10, and the weld nut 70 with which the mounting bolt 60 is screwed may be disposed at the substantially central lower portion of the front of the driving device 1 corresponding to the third supporting point 13. In other words, the mounting bolts 60 may be configured to fix the mounting bracket 10 to the left and right sides of the rear of the driving device 1 by being coupled to the mount ribs 7 of the driving device 1 and the inner pipes 53 of the rubber bushes 50 at the first and second supporting points 11 and 12 of the mounting bracket 10 and by being fastened to the weld nuts 70 of the first and second supporting points 11 and 12.

In addition, the mounting bolt 60 may be configured to fix the mounting bracket 10 to the substantially central lower portion of the front of the driving device 1 by being coupled to the inner pipe 53 of the rubber bush 50 at the third supporting point 13 of the mounting bracket 10 and being fastened to the weld nut 70 of the substantially central lower portion of the front of the driving device 1. Particularly, the rubber bushes 50 attached to the first and second supporting points 11 and 12 may be disposed at the substantial center of mass of the driving device 1, and the rubber bush 50 attached to the third supporting point 13 may be disposed under the substantial center of mass of the driving device 1.

Accordingly, in accordance with the mounting unit 100 of a driving device for a vehicle according to the exemplary embodiment of the present invention having the above-stated configuration, it may be possible to support the left and right sides of the rear of the driving device 1 at the first and second supporting points 11 and 12 of the mounting bracket 10 using the rubber bushes 50 and to support the substantially central lower portion of the front of the driving device 1 at the third supporting point 13 with a height difference with the respect to the first and second supporting points 11 and 12 using the rubber bush 50.

Therefore, in the exemplary embodiment of the present invention, when the impact is transferred to the driving device 1 from the vehicle body 3 and the vibration generated in the driving device 1 is transferred to the vehicle body 3, it may be possible to attenuate the impact transferred to the driving device 1 from the vehicle body 3 and the vibration transferred to the vehicle body 3 from the driving device 1 while minimizing displacement in the back and forth direction and in the left and right direction of the driving device 1 (e.g., in the x-axis and z-axis direction).

Furthermore, in the exemplary embodiment of the present invention, it may be possible to reduce stress applied to the rubber bushes 50 by minimizing the displacement in the back and forth direction and in the left and right direction of the driving device 1, Accordingly, in the exemplary embodiment of the present invention, it may be possible to design the rubber bushes 50 to allow the rubber bushes to have a shape and a material having substantial low stiffness (e.g., lower than the related art), and to improve performance of the vehicle by reducing the stiffness of the rubber bushes 50 to suppress the vibration generated in the driving device 1 from being transferred to the vehicle body 3. In addition, in the exemplary embodiment of the present invention, manufacturing cost may be reduced by using three rubber bushes, unlike the related art in which four or more rubber bushes are used.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

### DESCRIPTION OF SYMBOLS

1 . . . Driving device
2 . . . Housing
3 . . . Vehicle body
7 . . . Mount rib
10 . . . Mounting bracket
11 . . . First supporting point
12 . . . Second supporting point
13 . . . Third supporting point
21 . . . First part
22 . . . Second part
50 . . . Rubber bush
51 . . . Outer pipe
53 . . . Inner pipe
55 . . . Insulator
60 . . . Mounting bolt
70 . . . Weld nut

What is claimed is:

1. A mounting unit of a driving device for a vehicle for attaching the driving device having a rotary component to a vehicle body, the mounting unit comprising:
a mounting bracket attached to the vehicle body; and
a plurality of rubber bushes respectively disposed at both sides of the mounting bracket corresponding to a first side of the driving device and at a substantial center of the mounting bracket corresponding to a second side of the driving device, and configured to fix the mounting bracket to the driving device using a plurality of mounting bolts.

2. The mounting unit of a driving device for a vehicle of claim 1, wherein:
the rubber bushes are respectively disposed at left and right sides of any one of a front and a rear of the mounting bracket corresponding to the first side of the driving device and at a substantial center of another side of the mounting bracket corresponding to the second side of the driving device using a back and forth direction, a left and right direction, and an up and down direction of the mounting bracket as a reference.

3. The mounting unit of a driving device for a vehicle of claim 1, wherein:
the rubber bushes are respectively disposed at left and right sides of a rear of the mounting bracket corresponding to a rear of the driving device and at a substantial center of a front of the mounting bracket corresponding to a front of the driving device using a back and forth direction, a left and right direction, and an up and down direction of the mounting bracket as a reference.

4. The mounting unit of a driving device for a vehicle of claim 1, wherein:
the rubber bushes are respectively disposed at left and right sides of a rear of the mounting bracket corresponding to a rear of the driving device and at a substantial center of a front of the mounting bracket corresponding to a substantially central lower portion of a front of the driving device.

5. The mounting unit of a driving device for a vehicle of claim 1, wherein:
the mounting bracket is configured to support the driving device in a three-point supporting manner using the rubber bushes.

6. The mounting unit of a driving device for a vehicle of claim 1, wherein the mounting bracket includes:
first and second supporting points disposed at both sides of the mounting bracket to support the first side of the driving device using the rubber bushes; and
a third supporting point disposed at the substantial center of the mounting bracket to support the second side of the driving device using the rubber bush.

7. The mounting unit of a driving device for a vehicle of claim 4, wherein the mounting bracket includes:
first and second supporting points disposed at both sides of the rear of the mounting bracket to respectively support both sides of the rear of the driving device using the rubber bushes to be vertically symmetrical; and
a third supporting point disposed at the substantial center of the front of the mounting bracket to support the substantially central lower portion of the front of the driving device using the rubber bush.

8. The mounting unit of a driving device for a vehicle of claim 7, wherein:
the rubber bushes at the first and second supporting points are disposed at the substantial center of mass of the driving device.

9. The mounting unit of a driving device for a vehicle of claim 1, wherein the mounting bracket includes:
a first part configured to support the second side of the driving device; and
second parts integrally connected to both ends of the first part, and configured to support the first side of the driving device.

10. The mounting unit of a driving device for a vehicle of claim 9, wherein:
the second parts include connection ends connected to both ends of the first part, and free ends that correspond to the connection ends.

11. The mounting unit of a driving device for a vehicle of claim 10, wherein:
the first and second supporting points are disposed at positions that extend upwards from the free ends of the second parts; and
the third supporting point is disposed at a substantial center of the first part.

12. The mounting unit of a driving device for a vehicle of claim 10, wherein the rubber bushes each include:
an outer pipe attached to each of the supporting points of the mounting bracket;
an inner pipe disposed within the outer pipe; and
an insulator disposed between the outer pipe and the inner pipe and bonded onto an inner surface of the outer pipe and an outer surface of the inner pipe.
